(19) United States
(12) Patent Application Publication
(10) Pub. No.: US 2025/0322431 A1
(43) Pub. Date: Oct. 16, 2025

(54) INFORMATION PROCESSING DEVICE AND INFORMATION PROCESSING METHOD

(71) Applicant: Toshiba Tec Kabushiki Kaisha, Tokyo (JP)

(72) Inventor: Takahiro OGISU, Mishima Shizuoka (JP)

(21) Appl. No.: 19/048,487

(22) Filed: Feb. 7, 2025

(30) Foreign Application Priority Data
Apr. 10, 2024 (JP) 2024-063594

(51) Int. Cl. G06Q 30/0251

(52) U.S. Cl. CPC G06Q 30/0269; G06Q 30/0261

(57) ABSTRACT

According to one embodiment, an information processing device includes a control unit and a communication unit to communicate with an edge device. The control unit is configured to acquire an attribute of a customer visiting a store and generate an inquiry prompt for providing a promotional recommendation of merchandise items for sale at the store to the customer. The inquiry prompt is generated based on condition information including at least the attribute of the customer. The control unit inputs the inquiry prompt to a functionalized generative AI to generate a response, then extracts a merchandise item corresponding to description information in the generated response from among the various merchandise items available for sale at the store, and generates sales promotion information for the extracted merchandise item based on merchandise information of the extracted merchandise item and the description information in the generated response.

### CROSS-REFERENCE TO RELATED APPLICATION

This application is based upon and claims the benefit of priority from Japanese Patent Application No. 2024-063594, filed Apr. 10, 2024, the contents of which are incorporated herein by reference.

### FIELD

Embodiments described herein relate generally to an information processing device and an information processing method.

### BACKGROUND

In the related art, at a retail store such as a department store or a supermarket, a merchandise item available for sale at the store may be advertised by a promotion on a paper medium or the like such as a printed coupon. There also has been proposed in the related art a technique of automatically generating an advertisement based on the general field to which a merchandise item to be advertised belongs.

However, with the above methods, the same or similar promotions of a merchandise item may be provided to all customers similarly. Therefore, there is room for improvement regarding the specific or targeted appeal of a merchandise item in prepared promotions.

### BRIEF DESCRIPTION OF THE DRAWINGS

FIG. 1 is a schematic view of an information processing system according to an embodiment.

FIG. 2 is a block diagram of an edge device.

FIG. 3 is a block diagram of an edge server.

FIG. 4 shows an example of a data configuration of a merchandise master.

FIG. 5 shows an example of a data configuration of a prompt database.

FIG. 6 is a block diagram showing an example of the functional aspects of an edge device.

FIG. 7 is a block diagram showing an example of the functional aspects of an edge server.

FIG. 8 shows an example of sales promotion information generated by an edge server.

FIG. 9 shows another example of sales promotion information.

FIG. 10 is a sequence chart showing an example of control processing in an information processing system of an embodiment.

### DETAILED DESCRIPTION

An embodiment described herein is to provide an information processing device and an information processing method for generating sales promotion information that improves the appeal of merchandise items available for sale at a store to a customer visiting the store.

In general, according to one embodiment, an

information processing device for in-store customer product recommendation system is described. Such an information processing device includes a communication unit to communicate with an edge device, a memory unit, and a control unit. The control unit is configured to: acquire an attribute of a customer visiting a store and using the edge device; generate an inquiry prompt for providing a promotional recommendation of merchandise items for sale at the store to the customer, the inquiry prompt being generated based on condition information including at least the acquired attribute of the customer; input the inquiry prompt to a generative AI functionalized to generate a response and acquire the generated response from the generative AI; extract a merchandise item corresponding to description information in the generated response from among the merchandise items available for sale at the store in a merchandise master in the memory unit; and generate sales promotion information for the extracted merchandise item based on merchandise information of the extracted merchandise item and the description information about the merchandise item in the generated response.

An information processing device and an information processing method according to certain example embodiment will now be described with reference to the drawings. In the embodiment described below, an edge server installed in a store such as a department store or a supermarket (an example of a facility) is described as an example of the information processing device. However, these specific example embodiments do not limit the present disclosure.

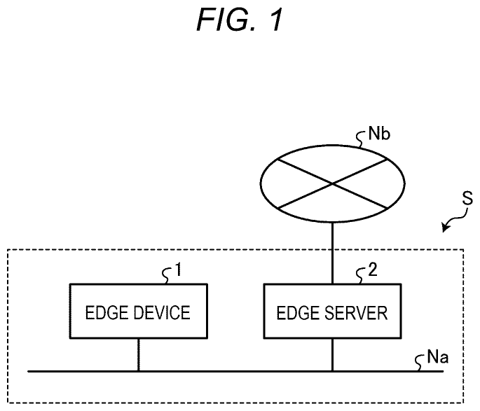

FIG. 1 is a schematic view showing a schematic configuration of an information processing system S according to an embodiment. As shown in FIG. 1, the information processing system S includes an edge device 1 and an edge server 2.

The edge device 1 and the edge server 2 are communicably connected to each other via a network Na such as a local area network (LAN). The edge server 2 is communicably connected to a network Nb, such as the internet.

The number of edge devices 1 connected to the edge server 2 is not limited to the illustrated example.

The edge device 1 is generally a device installed at a store. The edge device 1 may also be a device of various kinds serving as a contact point between a customer visiting a store and the information processing system S or a system incorporating such a device. For example, the edge device 1 may be an information processing device such as a self-service point-of-sale (POS) terminal, a smartphone of the customer, or a tablet terminal provided at the store for customer use.

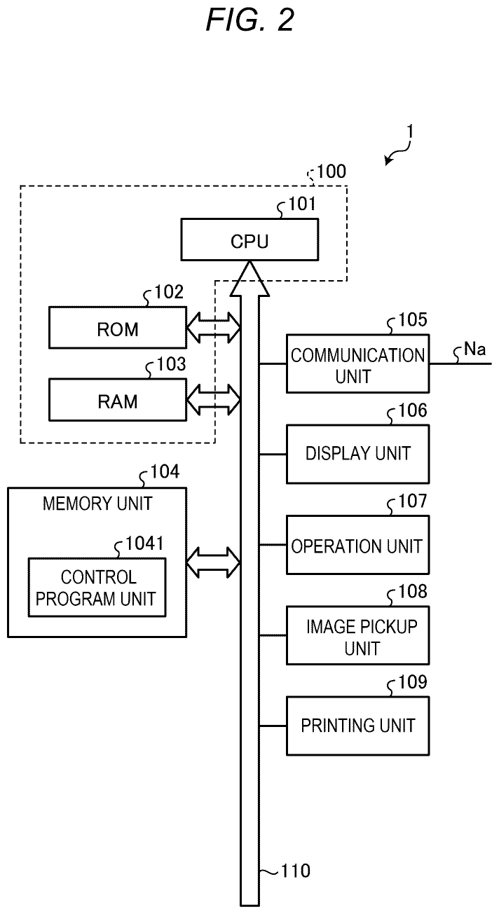

The edge device 1 exchanges various information with the edge server 2. Specifically, the edge device 1 picks up an image (also referred to as a customer image) of a customer at the store using an image pickup unit 108 (see FIG. 2). The edge device 1 transmits the customer image to the edge server 2. Upon receiving sales promotion information from the edge server 2, the edge device 1 outputs the sales promotion information using a printing unit 109 of the edge device 1.

In this context, a customer image is, for example, an image showing the face of a customer. The customer image may be an image showing the whole body of a customer so that the clothing of the customer can be seen. Preferably, the customer image shows just one customer (an image pickup target).

The edge server 2 is a server device installed at a data center or the like, in the store or outside the store. The edge server 2 generates sales promotion information for a merchandise item to be suggested to the customer from among the merchandise items available for sale at the store.

Specifically, upon receiving the customer image from the edge device 1, the edge server 2 extracts feature data from the customer image representing features related to the external appearance of the customer (hereinafter referred to generally as feature data) using a known image recognition technique or the like. The edge server 2 estimates one or more customer attributes such as the customer's age or gender from the extracted feature data and thus acquires a customer attribute of the customer shown in the customer image.

The edge server 2 also acquires environment information related to the surroundings or current circumstances of the store via the network Nb. The edge server 2 acquires, for example, external data such as the weather and temperature in the surroundings of the store from an external server such as a server providing meteorological data. In some examples, edge server 2 may acquire external data from a sensor device such as a temperature sensor installed outside of the store.

The edge server 2 sends a prompt that has been generated based on an estimated customer attribute and the acquired external data to a merchandise item suggestion LLM 2043, and thus acquires a merchandise related text (also referred to as a merchandise text) generated by the merchandise item suggestion LLM 2043.

The edge server 2 then extracts a merchandise item from among merchandise items registered in a merchandise master 2042 based on information described in the merchandise text. Subsequently, the edge server 2 generates sales promotion information for the extracted merchandise item using the merchandise information of the extracted merchandise item or the like. The edge server 2 then transmits the generated sales promotion information to the edge device 1.

The edge server 2 may perform processing for collecting information about overall merchandise sales and specific merchandise registrations from a POS terminal or the like. For example, the edge server 2 may acquire information such as the total numbers of merchandise items purchased at a store or the sales trend information as external data from a POS terminal or the like. The edge server 2 may also decide an order for listing different merchandise items when multiple merchandise items are extracted from the merchandise master 2042 or for generating the sales promotion information based on such external data acquired from a POS terminal or otherwise.

FIG. 2 is a block diagram showing an example of the hardware configuration of the edge device 1 according to the embodiment.

As shown in FIG. 2, the edge device 1 has a central processing unit (CPU) 101, as an example of a processor, a read-only memory (ROM) 102, a random-access memory (RAM) 103, and a memory unit 104.

The CPU 101 manages and controls each part of the edge device 1. The ROM 102 stores various programs. The RAM 103 is a work space where programs and various data are loaded.

The memory unit 104 is a nonvolatile memory such as a hard disk drive (HDD) or a flash memory where stored information is held even when the power is turned off. The memory unit 104 has a control program unit 1041.

The control program unit 1041 stores a control program to control the edge device 1. The CPU 101, the ROM 102, the RAM 103, and the memory unit 104 are coupled to each other via a bus 110. The CPU 101, the ROM 102, and the RAM 103 form a control unit 100 having a computer configuration. That is, the control unit 100 executes control processing of the edge device 1 by causing the CPU 101 to operate according to the control program unit 1041 stored in the ROM 102 or the memory unit 104 and loaded in the RAM 103.

The control unit 100 is coupled to a communication unit 105, a display unit 106, an operation unit 107, the image pickup unit 108, and the printing unit 109 via the bus 110.

The communication unit 105 is a communication interface such as a LAN interface (I/F) and is connected to the network Na. The communication unit 105, for example, transmits and receives various information to and from the edge server 2 via the network Na.

The display unit 106 is a display device such as a liquid crystal display (LCD). The display unit 106 displays various information related to the sales promotion information under the control of the CPU 101. The display unit 106 may be a display device such as a signage.

The operation unit 107 is implemented, for example, by a touch panel. The operation unit 107 accepts various inputs from the customer. The operation unit 107 may be an input device such as a keyboard and/or a pointing device.

The image pickup unit 108 can be a camera or the like. The image pickup unit 108 has a solid-state image pickup element such as a charge-coupled device (CCD) or a complementary MOS (CMOS) imaging device. In this embodiment, the image pickup unit 108 is provided on the side of the edge device 1 where the display unit 106 is provided. The image pickup unit 108 takes a picture (image) of the customer while the customer is operating the edge device 1.

The printing unit 109 comprises a printing device. The printing unit 109 includes a print head and a sheet conveyance mechanism or the like and performs printing (image formation) on a print medium, such as paper, based on an instruction from the control unit 100. For example, the printing unit 109 prints the sales promotion information received from the edge server 2 on a print medium, under the control of the control unit 100. The printing method of the printing unit 109 is not particularly limited.

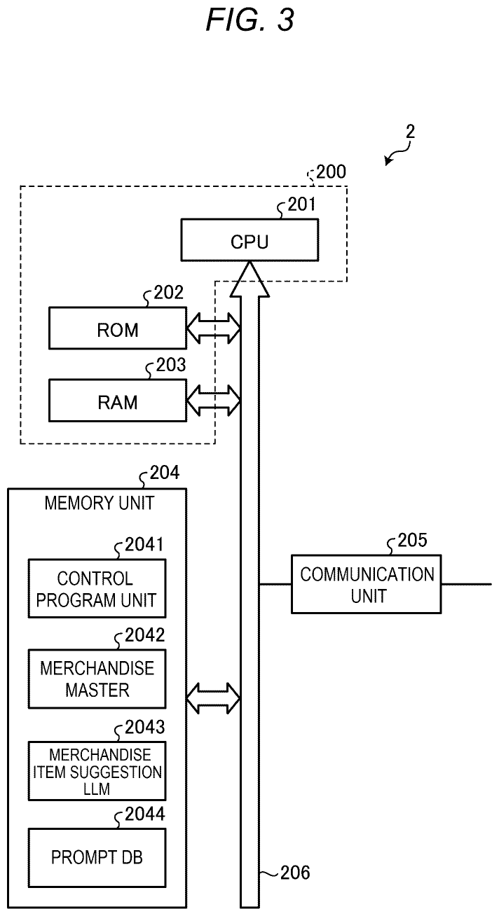

FIG. 3 is a block diagram showing an example of the hardware configuration of the edge server 2 according to an embodiment.

As shown in FIG. 3, the edge server 2 has a CPU 201 as an example of a processor, a ROM 202, a RAM 203, and a memory unit 204.

The CPU 201 manages and controls each part of the edge server 2. The ROM 202 stores various programs. The RAM 203 is a work space where programs and various data are loaded.

The memory unit 204 is a nonvolatile memory such as an HDD or a flash memory where stored information is held even when the power is turned off. The memory unit 204 has a control program unit 2041, the merchandise master 2042, the merchandise item suggestion LLM 2043, and a prompt DB 2044.

The memory unit 204 also stores a prompt template database. The prompt template database is a data table or a database storing a prompt template corresponding to different prompt types or the like stored in the prompt DB 2044. The memory unit 204 also stores a sales promotion information template database

The control program unit 2041 stores a control program to control the edge server 2. The CPU 201, the ROM 202, the RAM 203, and the memory unit 204 are coupled to each other via a bus 206. The CPU 201, the ROM 202, and the RAM 203 form a control unit 200 having a computer configuration. That is, the control unit 200 executes control processing of the edge server 2 by causing the CPU 201 to operate according to the control program unit 2041 stored in the ROM 202 or the memory unit 204 and loaded in the RAM 203.

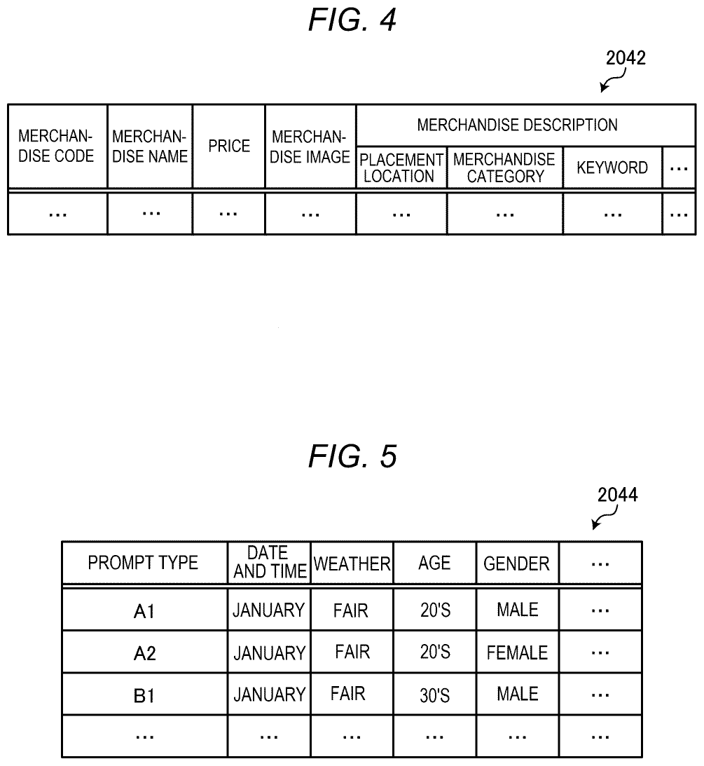

Merchandise master 2042 is a data table or a database to manage the merchandise information of the merchandise items available for sale at the store. FIG. 4 shows an example of the data configuration of the merchandise master 2042. As shown in

FIG. 4, the merchandise master 2042 stores merchandise information (such as the merchandise name, merchandise price, merchandise image, and merchandise description of the merchandise item) in association with a merchandise code that can identify the type of a merchandise item available for sale at the store.

The merchandise description includes, for example, information such as a placement location of the merchandise item in the store, a merchandise category, and a keyword. The merchandise category can be a broader category in which the merchandise item corresponding to the merchandise code falls. A plurality of merchandise categories may be stored for an individual merchandise item. For example, “fruit”, “orange”, “foodstuff”, “beverage” and the like may be stored as merchandise categories corresponding to a merchandise name “orange juice”.

The keyword can be a word or text representing or describing a feature of the merchandise item such as information about the type, style, and production method of the merchandise item, the country of origin, and/or the manufacturer of the merchandise item. A plurality of keywords may be stored for an individual merchandise item. For example, “100% pure fruit juice”, “product of USA” and the like are stored as keywords corresponding to the merchandise name “orange juice”.

The merchandise category and the keyword may be not limited to a format in a natural language and may be stored in a format of a semantic vector calculated by a known natural language processing technique or the like. The merchandise category and the keyword may be stored in multiple formats such as in a natural language format and i a semantic vector format.

The merchandise item suggestion LLM 2043 is generative AI that generates text responses to prompts. The merchandise item suggestion LLM 2043 is, for example, a large language model (LLM). The merchandise item suggestion LLM 2043 generates a “merchandise text” related to a merchandise item which is being recommended for purchase to the customer. In this example embodiment, an LLM is used as generative AI. However, the generative AI may be any other type of generative AI that can generate a text response and is not limited to an LLM.

The merchandise item suggestion LLM 2043 of this example is an LLM that is constructed by a deep learning technique and that, upon receiving an input of a text designating a condition, outputs a text about a merchandise item based on the input condition. For example, the condition is a reference condition that serves as a reference for deriving an output result or a limiting condition that serves to narrow down an output result.

The merchandise text is, for example, text data including or indicating the merchandise name of a merchandise item to be recommended/promoted, the merchandise category of the merchandise item, and content (hereinafter referred to as a promotion sentence) to promote the merchandise item. In some examples, the merchandise text may be text data in the form of a list including the names of a plurality of merchandise items, merchandise categories respectively corresponding to the plurality of items, and merchandise promotion sentences corresponding to each of the merchandise items.

In response to an input of an inquiry text (hereinafter also referred to as a prompt), the merchandise item suggestion LLM 2043 generates a merchandise text corresponding to this input. The prompt (inquiry text) comprises an instruction sentence (providing an instruction to generate a merchandise text) along with additional content related to external data, such as the weather and temperature, and customer information, such as a customer's attribute information or the like.

The prompt DB 2044 is a data table or a database

storing prompts in correlation with customer attribute information and external data. FIG. 5 shows an example of the data configuration of the prompt DB 2044. As shown in FIG. 5, the prompt DB 2044 stores prompt types with associated specific date and time, weather, age, gender, and the like values.

The prompt type is identification information to identify a prompt corresponding to the content of a data entry of the date and time, weather, age, gender, or the like stored in the prompt DB 2044. A prompt template correlated with the prompt type can be stored template database established in the memory unit 204. The date and time, and the weather are examples of external data. The age and the gender are an example of attribute information representing customer attributes.

Referring back to FIG. 3, the control unit 200 is coupled to a communication unit 205 via the bus 206.

The communication unit 205 is a communication interface such as a LAN I/F and is connected to the networks Na, Nb. The communication unit 205, for example, transmits and Nb. receives various information to and from the edge device 1 and an external server via the networks Na, Nb.

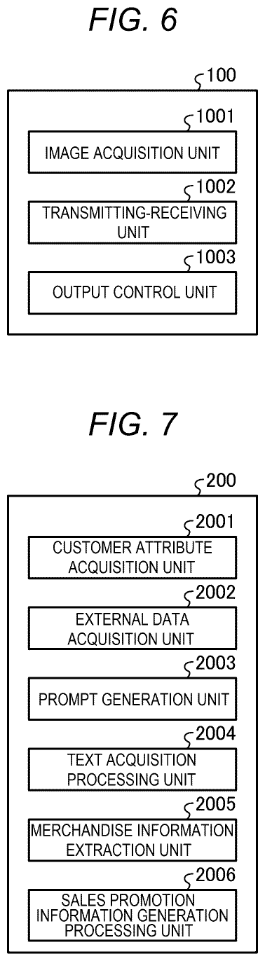

FIG. 6 is a block diagram showing an example of functional aspects of the edge device 1. As shown in FIG. 6, the control unit 100 provides an image acquisition unit 1001, a transmitting-receiving unit 1002, and an output control unit 1003. However, the functional configuration of the edge device 1 is not limited to this.

The control unit 100 (CPU 101) of the edge device 1 implements the above functional configuration by executing the control program unit 1041 stored in the memory unit 104. In this embodiment, the above functional configuration is a software configuration implemented by cooperation between the processor of the edge device 1 and the program. However, this is not limiting. A part or all of the functions may be provided by a hardware configuration implemented by a dedicated circuit or the like.

The image acquisition unit 1001 acquires a customer image of a customer visiting the store. Specifically, upon receiving an operation from the operation unit 107 of the edge device 1, the image acquisition unit 1001 picks up the customer image, using the image pickup unit 108. The image acquisition unit 1001 then acquires the customer image.

The image acquisition unit 1001 may acquire a customer image from any networked camera or the like that is provided inside the store instead from the image pickup unit 108 of the edge device 1. The image acquisition unit 1001 may also execute the image pickup of the customer image not only in response to the acceptance of an operation from the operation unit 107 but also in response to, for example, the detection of the customer via a sensor that is installed in the store. The image acquisition unit 1001 may also execute the image pickup of the customer image, for example, in response to the detection of a voice of the customer via a microphone that is installed in the store.

The transmitting-receiving unit 1002 transmits and receives various information to and from the edge server 2. Specifically, as the image acquisition unit 1001 acquires the customer image, the transmitting-receiving unit 1002 transmits the customer image to the edge server 2. The transmitting-receiving unit 1002 receives sales promotion information from the edge server 2.

The output control unit 1003 outputs the sales promotion information. Specifically, the output control unit 1003 controls the printing unit 109 to print (output) the sales promotion information received by the transmitting-receiving unit 1002.

The output control unit 1003 may also control the display unit 106 and thus cause the display unit 106 to display (output) the sales promotion information received by the transmitting-receiving unit 1002.

FIG. 7 is a block diagram showing an example of the functional aspects of the edge server 2. As shown in FIG. 7, the control unit 200 provides a customer attribute acquisition unit 2001, an external data acquisition unit 2002, a prompt generation unit 2003, a text acquisition processing unit 2004, a merchandise information extraction unit 2005, and a sales information generation processing unit 2006. However, the functional configuration of the edge server 2 is not limited to this.

The control unit 200 (CPU 201) of the edge server 2 implements the above functional configuration by executing the control program unit 2041 stored in the memory unit 204. In this embodiment, the above functional configuration is a software configuration implemented by cooperation between the processor of the edge server 2 and the program. However, this is not limiting. A part or all of the functions may be provided by a hardware configuration implemented by a dedicated circuit or the like.

The customer attribute acquisition unit 2001 is an example of a first acquisition unit. The customer attribute acquisition unit 2001 acquires a customer attribute of the customer visiting the store. Specifically, upon receiving the customer image transmitted from the transmitting-receiving unit 1002 of the edge device 1, the customer attribute acquisition unit 2001 extracts feature data of the customer image. The customer attribute acquisition unit 2001 estimates a customer attribute from the extracted feature data and acquires the estimated customer attribute. When extracting the feature data from the customer image, it is preferable to extract the feature data based on a part where a feature such as the age or gender of the customer tends to appear, like the face of the customer, in order to improve the accuracy of estimation of the customer attribute.

The external data acquisition unit 2002 acquires various information from an external server or the like. Specifically, the external data acquisition unit 2002 acquires external data such as the current weather and temperature from the external server via the network Nb.

The external data acquisition unit 2002 may also acquire external data, for example, from a sensor device such as a temperature sensor installed outside the store. The external data acquisition unit 2002 may also acquire information such as the number of merchandise items purchased or the sales trend from a POS termina as external data.

The prompt generation unit 2003 is an example of a first generation unit. The prompt generation unit 2003 generates inquiry text based on information including the customer an attribute(s) and the external data, and an instruction sentence giving an instruction to generate a merchandise text. Specifically, the prompt generation unit 2003 acquires a prompt type that matches (or best matches) the customer attribute(s) and the external data by referring to the prompt DB 2044.

Preferably, when acquiring a prompt type, the prompt generation unit 2003 may acquire a prompt type with a perfect match between the customer attribute(s) and the external data, and the content of each data entry in the prompt DB 2044. However, the prompt generation unit 2003 may acquire a prompt type with a highest matching between the customer attribute(s) and the external data, and the content of each data entry in the prompt DB 2044.

The prompt generation unit 2003 then refers to a prompt template database in the memory unit 204 and acquires a prompt template corresponding to the prompt type from among prompt templates stored in the prompt template database. The prompt generation unit 2003 then incorporates the customer attribute(s) and the external data into the acquired prompt template and thus generates a prompt. The prompt template includes the instruction sentence giving an instruction to generate a merchandise text.

The text acquisition processing unit is 2004 an example of a second acquisition unit. The text acquisition processing unit 2004 inputs the inquiry text to the merchandise item suggestion LLM 2043, which has been functionalized to generate a text about a merchandise item in response to the instruction content of the inquiry text, and thus acquires a merchandise text generated by the merchandise item suggestion LLM 2043. Specifically, the text acquisition processing unit 2004 inputs the prompt generated by the prompt generation unit 2003 to the merchandise item suggestion LLM 2043. Subsequently, the text acquisition processing unit 2004 acquires a merchandise text generated by the merchandise item suggestion LLM 2043.

The merchandise information extraction unit 2005 is an example of an extraction unit. The merchandise information extraction unit 2005 extracts a merchandise item, based on the information about a merchandise item described in the merchandise text. For example, the merchandise information extraction unit 2005 extracts, from the merchandise master 2042, the merchandise information of a merchandise item having merchandise information including a merchandise category similar to the merchandise category included in the merchandise text acquired by the text acquisition processing unit 2004.

As a method for extracting a merchandise item included in a merchandise category similar to a merchandise category included in the merchandise text, the merchandise information extraction unit 2005 vectorizes the merchandise category included in the merchandise text using a known technique of natural language processing. Subsequently, the merchandise information extraction unit 2005 calculates the degree of vector similarity between the vectorized merchandise category and a merchandise category vectorized in advance that has been stored in the merchandise master 2042. The merchandise information extraction unit 2005 extracts, from the merchandise master 2042, the merchandise information of a merchandise item having merchandise information including a merchandise category with a degree of vector similarity equal to or higher than some predetermined threshold. At this point, the merchandise information extraction unit 2005 may extract a plurality of pieces of merchandise information from the merchandise master 2042.

In the case of further giving an order of priority to the merchandise information extracted from the merchandise master 2042, the merchandise information extraction unit 2005 may decide the order of priority, for example, based on the merchandise price, the merchandise description, and the like included in the merchandise information. example, For the merchandise information extraction unit 2005 may preferentially extract the merchandise information of a merchandise item with a low merchandise price or a merchandise item currently promoted at the store, or the like.

The sales promotion information generation processing unit 2006 is an example of a second generation unit. The sales promotion information generation processing unit 2006 generates sales promotion information of the merchandise item extracted by the merchandise information extraction unit 2005. Specifically, the sales promotion information generation processing unit 2006 generates sales promotion information, based on the merchandise information extracted from the merchandise master 2042 by the merchandise information extraction unit 2005 based on the merchandise text, and the promotion sentence included in the merchandise text.

At this point, the sales promotion information generation processing unit 2006 generates sales promotion information by typesetting of the merchandise information of the merchandise item and the promotion sentence included in the merchandise text in correlation with each other, on a per merchandise item (information) basis extracted by the merchandise information extraction unit 2005.

As a method for generating sales promotion information, for example, the sales promotion information generation processing unit 2006 refers to the sales promotion information template database in the memory unit 204, and incorporates the merchandise information and the promotion sentence included in the merchandise text into a sales promotion information template stored in the sales promotion information template database, and thus generates sales promotion information.

At this point, as the sales promotion information template, a template including information about the store such as the store name, the location of the store, and the floor map of the store, and the merchandise information of a merchandise item currently promoted at the store or price reduction information (coupon or the like) of a merchandise item, may be There may be a plurality of sales promotion information used. templates, and the sales promotion information templates may be configured to be switched, depending on the customer attribute, the external data, and the like.

The sales promotion information generation processing unit 2006 may also decide the order of listing merchandise items to be incorporated in the sales promotion information when generating the sales promotion information, based on the external data acquired from the POS terminal. For example, the sales promotion information generation processing unit 2006 may generate the sales promotion information by performing typesetting such that information made up of the merchandise information and the promotion sentence is arranged in order from the largest number of items purchased or in order from the highest sales.

The sales promotion information generation processing unit 2006 transmits the generated sales promotion information to the edge device 1.

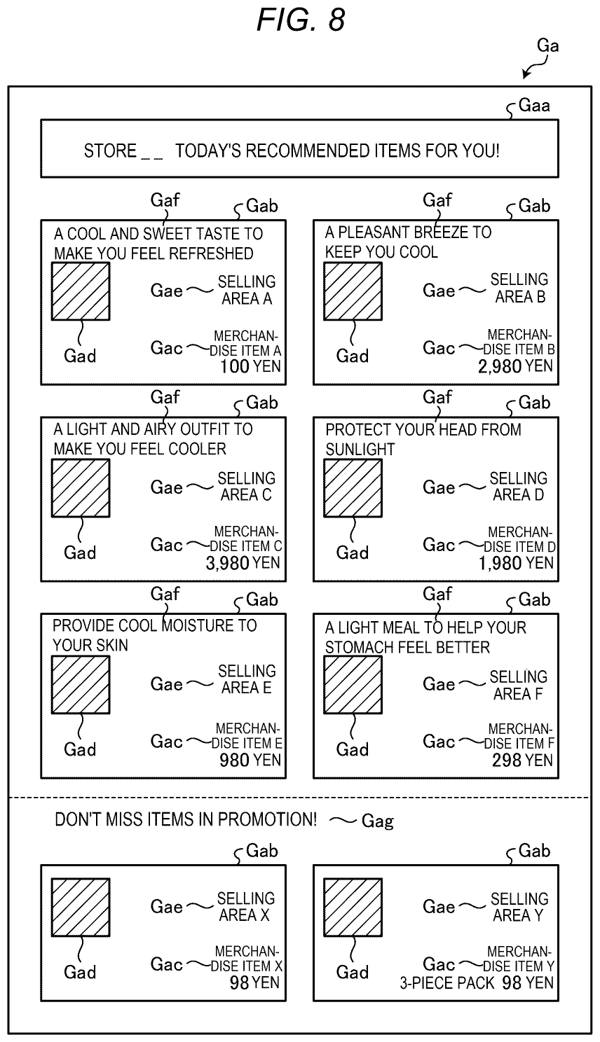

Aspects related to the sales promotion information printed by the printing unit 109 of the edge device 1 will now be described. The output control unit 1003 of the edge device 1 controls the printing unit 109 to output sales promotion information as shown in FIG. 8, for example. FIG. 8 shows an example of the sales promotion information generated by the edge server 2. As shown in FIG. 8, the sales promotion information has an area Gaa, an area Gab, and the like, in a sales promotion information area Ga.

In the area Gaa, information about the store such as the store name, and a text to promote a merchandise item to the customer visiting the store, are displayed. The area Gab is provided on a per merchandise item basis using merchandise information extracted by the merchandise information extraction unit 2005 of the edge server 2. For example, the area Gab includes display areas such as an area Gac, an area Gad, an area Gae, an area Gaf, and an area Gag, related to the display of the merchandise information.

In the area Gac, a merchandise name and merchandise price included in the merchandise information extracted by the merchandise information extraction unit 2005 are displayed. In the area Gad, a merchandise image included in the merchandise information extracted by the merchandise information extraction unit 2005 is displayed.

In the area Gae, a placement location included in the merchandise information extracted by the merchandise information extraction unit 2005 is displayed. In the area Gaf, a promotion sentence from the merchandise text corresponding to the merchandise information extracted by the merchandise information extraction unit 2005 is displayed. In the area Gag, various merchandise information of any merchandise item currently being promoted at the store can be displayed.

The above sales promotion information is generated from the promotion sentence included in the merchandise text that was generated based on the customer attribute, the external data, and the merchandise information of the merchandise item extracted from the merchandise master 2042. In other words, the above sales promotion information is a display of merchandise information for a merchandise item personalized in its selection in presentation for the customer. Thus, the appeal of merchandise items available for sale at the store can be improved as the customer views the above sales promotion information.

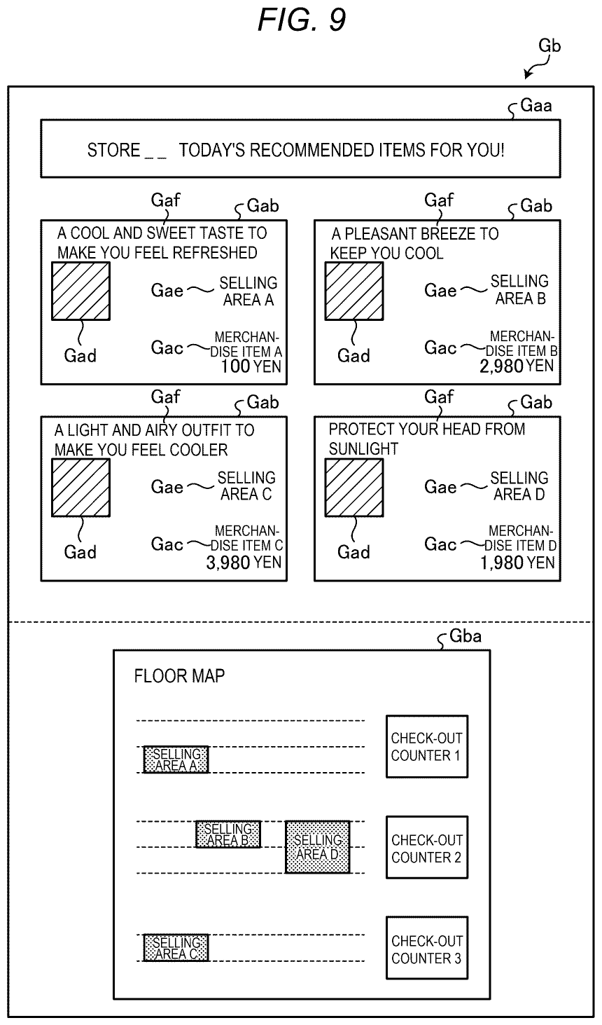

The sales promotion information printed by the printing unit 109 of the edge device 1 when a different sales promotion information template from FIG. 8 is used will now be described. The description of the same entry items as in FIG. 8 is omitted. The output control unit 1003 of the edge device 1 may cause the printing unit 109 to print sales promotion information as shown in FIG. 9, for example. FIG. 9 shows one example of the sales promotion information generated by the edge server 2. As shown in FIG. 9, the sales promotion information includes an area Gba in addition to the foregoing area Gaa, in a sales promotion information area Gb.

In the area Gba, a floor map of the store is displayed. Also, the location of the selling areas for each merchandise item in the area Gaa may be displayed as superimposed on the floor map.

In the above sales promotion information, the placement location of a merchandise item is visualized. Therefore, the purchase of the merchandise item by the customer can be supported as the customer views the sales promotion information.

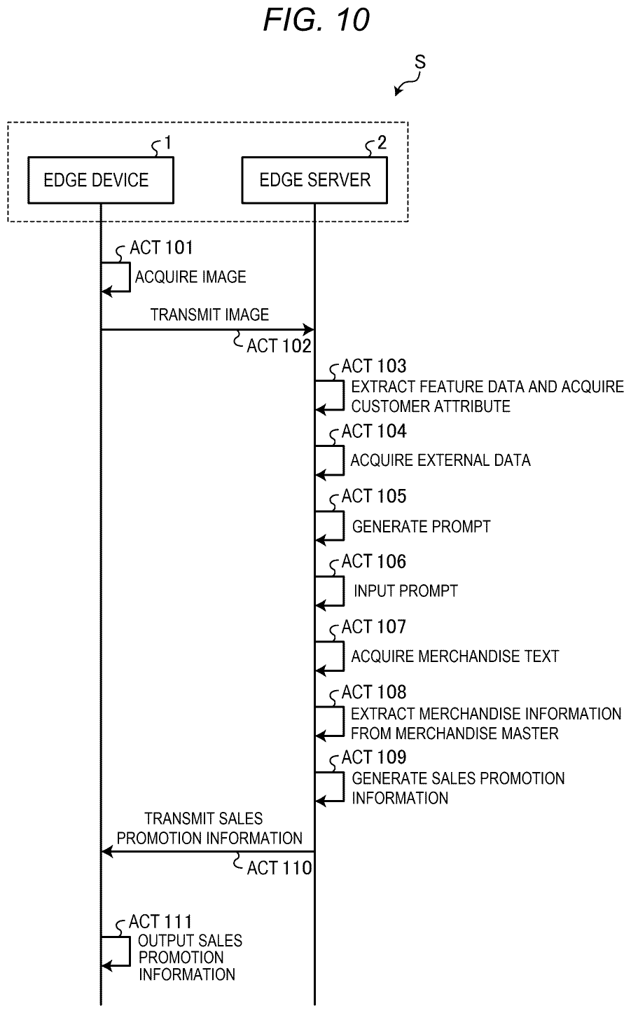

The control processing of the information processing system S will now be described. FIG. 10 is a sequence chart showing an example of the control processing of the information processing system S according to the embodiment. The sequence chart shown in FIG. 10 shows an example of processing in the case of transmitting a customer image acquired by the edge device 1 to the edge server 2, subsequently generating sales promotion information based on a merchandise text generated by the merchandise item suggestion LLM 2043 on the edge server 2, then transmitting the sales promotion information to the edge device 1, and printing (or otherwise outputting) the sales promotion information at the edge device 1.

First, upon accepting an operation giving an instruction to generate sales promotion information from the operation unit 107 performed by the operator of the edge device 1, the image acquisition unit 1001 of the edge device 1 thus acquires a customer image using the image pickup unit 108 (ACT 101). Subsequently, the transmitting-receiving unit 1002 of the edge device 1 transmits the customer image acquired by the image acquisition unit 1001 to the edge server 2 (ACT 102).

Upon receiving the customer image from the edge device 1, the customer attribute acquisition unit 2001 of the edge server 2 extracts feature data from the customer image. The customer attribute acquisition unit 2001 then estimates a customer attribute from the extracted feature data and thus acquires a customer attribute (ACT 103). Next, the external data acquisition unit 2002 of the edge server 2 acquires external data, such as the current weather and temperature, from the external server via the network Nb (ACT 104).

Next, the prompt generation unit 2003 of the edge server 2 acquires a prompt type that matches the customer attribute and the external data by referring to the prompt DB 2044. The prompt generation unit 2003 then acquires a prompt template corresponding to the prompt type from among prompt templates stored in a prompt template database or the like. The prompt generation unit 2003 incorporates the customer attribute and the external data into the acquired prompt template and thus generates a prompt (ACT 105).

Next, the text acquisition processing unit 2004 of the edge server 2 inputs the generated prompt to the merchandise item suggestion LLM 2043 (ACT 106). Accordingly, the text acquisition processing unit 2004 acquires a merchandise text generated by the merchandise item suggestion LLM 2043 (ACT 107).

Subsequently, the merchandise information extraction unit 2005 of the edge server 2 extracts, from the merchandise master 2042, the merchandise information of a merchandise item matching or having a similar merchandise category to the merchandise category included in the acquired merchandise text (ACT 108). Next, the sales promotion information generation processing unit 2006 of the edge server 2 generates sales promotion information using the merchandise information extracted from the merchandise master 2042 in ACT 108, the merchandise text overall, and the promotion sentence included in the merchandise text (ACT 109). Then, the sales promotion information generation processing unit 2006 of the edge server 2 transmits the sales promotion information to the edge device 1 (ACT 110).

When the transmitting-receiving unit 1002 of the edge device 1 receives the sales promotion information transmitted from the edge server 2, the output control unit 1003 controls the printing unit 109 to output the received sales promotion information (ACT 111).

As described above, in the information processing system S according to this embodiment, a merchandise related text is generated based on a customer attribute and external data. Then, merchandise information for a merchandise item similar to the generated merchandise related text is extracted from the merchandise master 2042 and sales promotion information is generated based on the extracted merchandise information and a promotion sentence included in the merchandise related text.

Thus, in the information processing system S according to this embodiment, since the merchandise related text is generated based on a customer attribute of a particular customer visiting the store and external relevant data, specific processing that reflects the attribute(s) of the customer can be performed. Also, in the information processing system S according to this embodiment, since a merchandise item available for sale at the store is extracted based on the merchandise text, customer personalized sales promotion information can be generated for the store. Thus, in the information processing system S according to this embodiment, sales promotion information that improves the appeal of a merchandise item available for sale at the store can be generated for the customer.

The above embodiment can be implemented with a suitable modification by changing a part of the configurations or functions of each of the above described devices. In the description below, some modification examples to the above embodiment are described as other embodiments. In the description below, differences from the already described embodiment are primarily described and the matters or aspects that are the same as those already described are generally not described again in detail. The modification examples described below may be implemented separately or may be combined with one another where appropriate.

### Modification Example 1

In an embodiment, the edge server 2 is configured to extract, based on a customer image picked up by the image pickup unit 108 of the edge device 1, feature data in the customer image, and then acquire a customer attribute from the extracted feature data. However, this is not limiting. The edge server 2 may be configured to read an ID card provided by the customer using a card reader or the like, via the edge device 1, and acquire a customer attribute corresponding to customer information on ID card thus read, from a customer master that is stored in the memory unit 204 of the edge server 2 or the like.

### Modification Example 2

In an embodiment, the prompt generation unit 2003 of the edge server 2 is configured to refer to the prompt DB 2044 and acquire a prompt template corresponding to a prompt type similar to the customer attribute and the external data from the prompt template database in the edge server 2. However, this is not limiting. The prompt generation unit 2003 may be configured to vectorize the customer attribute and the external data using a known technique of natural language processing, then calculate the degree of vector similarity between the vectorized customer attribute and external data and each prompt template (that has been vectorized in advance) that is stored in the prompt template database, and thus acquire a prompt template having a high degree of vector similarity.

### Modification Example 3

In an embodiment, the sales promotion information generation processing unit 2006 of the edge server 2 is configured to generate sales promotion information based on the merchandise information extracted from the merchandise master 2042 and the template of sales promotion information, and then transmit the generated sales promotion information to the edge device 1. However, this is not limiting. The sales promotion information generation processing unit 2006 may be configured to transmit the extracted merchandise information and the template of sales promotion information to a multifunction peripheral printer product (MFP) and cause the MFP to generate sales promotion information based on the provided merchandise information and the template of sales promotion information, and then print (or otherwise output) the sales promotion information.

### Modification Example 4

In an embodiment, the sales promotion information generation processing unit 2006 of the edge server 2 transmits the sales promotion information to the edge device 1 as the destination. However, this is not limiting. The sales promotion information generation processing unit 2006 may transmit the sales promotion information to a printing device, such as an MFP, or a display device, such as a digital signage, and thus output the sales promotion information via these devices. In other words, the sales promotion information generation processing unit 2006 of the edge server 2 may function as an example of an output unit that outputs the sales promotion information to one or both of a printing device and a display device.

### Modification Example 5

In an embodiment, the edge server 2 generates a prompt based on a customer attribute and external data. However, this is not limiting. The edge server 2 may generate a prompt based on the customer attribute alone without using the external data in generating the prompt.

The program executed by the information processing system S according to the embodiments and the modification examples may be configured to be stored in a computer connected to a network such as the internet and then downloaded via the network and thus provided. Also, the program executed by the information processing system S according to the embodiments and the modification examples may be configured to be provided or distributed via a network such as the internet.

The program executed by each device in the above embodiments can be incorporated in advance in the ROM, the memory unit or the like of such devices. The program executed by each device may be configured to be recorded as a file in an installable format or an executable format in a non-transitory, computer-readable recording medium such as a CD-ROM, a flexible disk (FD), a CD-R, or a digital versatile disk (DVD), and provided in this manner.

Also, the program executed by each device in the above embodiments may be configured to be stored in a computer connected to a network such as the internet and then downloaded via the network and thus provided. Also, the program executed by each device may be configured to be provided or distributed via a network such as the internet.

While an embodiment of the present disclosure has been described, this embodiment has been presented by way of example only, and is not intended to limit the scope of the disclosure. Indeed, the novel e modification examples thereof described herein may be embodied in a variety of other forms; furthermore, various omissions, substitutions, changes and combinations in the form of the embodiment described herein may be made without departing from the spirit of the disclosure. The accompanying claims and their equivalents are intended to cover such forms or modifications as would fall within the scope and spirit of the disclosure.

What is claimed is:

1. An information processing device for in-store customer product recommendation system, the device comprising:
a communication unit to communicate with an edge device;
a memory unit; and
a control unit configured to:
acquire an attribute of a customer visiting a store and using the edge device;
generate an inquiry prompt for providing a promotional recommendation of merchandise items for sale at the store to the customer, the inquiry prompt being generated based on condition information including at least the acquired attribute of the customer;
input the inquiry prompt to a generative AI functionalized to generate a response and acquire the generated response from the generative AI;
extract a merchandise item corresponding to description information in the generated response from among the merchandise items available for sale at the store in a merchandise master in the memory unit; and
generate sales promotion information for the extracted merchandise item based on merchandise information of the extracted merchandise item and the description information about the merchandise item in the generated response.

2. The information processing device according to claim 1, wherein the control unit is further configured to acquire external data associated with the store.

3. The information processing device according to claim 2, wherein the condition information further includes the external data associated with the store.

4. The information processing device according to claim 3, wherein the external data includes environment information related to the surroundings of the store.

5. The information processing device according to claim 4, wherein the environment information includes a current temperature and a current weather state.

6. The information processing device according to claim 1, wherein the extracted merchandise item is extracted based on a degree of similarity between description information in the generated response and merchandise information of the merchandise items available for sale at the store.

7. The information processing device according to claim 1, wherein a plurality of merchandise items are extracted.

8. The information processing device according to claim 7, wherein the control unit is further configured to generate sales promotion for each extracted merchandise item based on merchandise information of the extracted merchandise items and the description information about the merchandise items in the generated response.

9. The information processing device according to claim 1, wherein the control unit is further configured to output the generated sales promotion information to a printing device.

10. The information processing device according to claim 1, wherein the control unit is further configured to output the generated sales promotion information to a display device.

11. The information processing device according to claim 1, wherein the inquiry prompt is generated by selection from a prompt database in the memory unit.

12. The information processing device according to claim 1, wherein the generative AI is a large language model (LLM).

13. The information processing device according to claim 1, wherein the attribute of the customer is acquired by analysis of an image of the customer provided by the edge device via the communication unit.

14. An in-store customer product recommendation system, comprising:
an edge device in a store;
an information processing device including:
a communication unit to communicate with the edge device;
a memory unit; and
a control unit configured to:
acquire an attribute of a customer visiting the store and using the edge device;
generate an inquiry prompt for providing a promotional recommendation of merchandise items for sale at the store to the customer, the inquiry prompt being generated based on condition information including at least the acquired attribute of the customer;
input the inquiry prompt to a generative AI functionalized to generate a response and acquire the generated response from the generative AI;
extract a merchandise item corresponding to description information in the generated response from among the merchandise items available for sale at the store in a merchandise master in the memory unit; and
generate sales promotion information for the extracted merchandise item based on merchandise information of the extracted merchandise item and the description information about the merchandise item in the generated response.

15. The in-store customer product recommendation system according to claim 14, wherein the control unit is further configured to acquire current environmental data associated with the store.

16. The in-store customer product recommendation system according to claim 15, wherein the control unit is further configured to output the generated sales promotion information to a printing device or a display at the store.

17. An information processing method, comprising:
acquiring an attribute of a customer who is visiting a store and using an edge device at the store;
generating an inquiry prompt for providing a promotional recommendation of merchandise items for sale at the store to the customer, the inquiry prompt being generated based on condition information including at least the acquired attribute of the customer;
inputting the inquiry prompt to a generative AI functionalized to generate a response and acquire the generated response from the generative AI;
extracting a merchandise item corresponding to description information in the generated response from among the merchandise items available for sale at the store in a merchandise master; and
generating sales promotion information for the extracted merchandise item based on merchandise information of the extracted merchandise item and the description information about the merchandise item in the generated response.

18. The information processing method according to claim 17, wherein the edge device is a point-of-sale terminal at the store.

19. The information processing method according to claim 18, wherein the condition information further includes a current temperature and a current weather state for the surroundings of the store.

20. The information processing method according to claim 17, further comprising:
outputting the generated sales promotion information to a printing device associated with the edge device.
